(19) United States
(12) Patent Application Publication
(10) Pub. No.: US 2026/0054376 A1
(43) Pub. Date: Feb. 26, 2026

(54) VERTICAL MULTI-JOINT ROBOT WRIST AXIS FASTENING STRUCTURE

(71) Applicant: YUILROBOTICS, CO. LTD., Incheon (KR)

(72) Inventors: Dongheon KIM, Seoul (KR); Jae Gwui KANG, Hwaseong-si, Gyeonggi-do (KR)

(73) Assignee: YUILROBOTICS, CO. LTD., Incheon (KR)

(21) Appl. No.: 19/099,469

(22) PCT Filed: Jul. 28, 2023
(86) PCT No.: PCT/KR2023/011057

§ 371 Date: Jun. 3, 2025

(30) Foreign Application Priority Data
Jul. 29, 2022 (KR) 10-2022-0094829

(51) Int. Cl. B25J 9/10; B25J 17/02

(52) U.S. Cl. CPC B25J 9/102; B25J 17/02

(57) ABSTRACT

The present invention relates to a vertical multi-joint robot wrist axis fastening structure. The present invention comprises: 5-axis bevel gear A having the other end connected to a 5-axis shaft, a bevel gear crest being formed on one end of the 5-axis bevel gear A, and the 5-axis bevel gear A being supported at a 6-axis shaft via a bearing; 5-axis bevel gear B meshing with a thread of the 5-axis bevel gear A at one end of the 5-axis shaft so as to convert the axis of rotation perpendicularly, the 5-axis bevel gear B being coupled to the input axis of a 5-axis reducer and fixed by a first nut; 6-axis bevel gear A positioned on the front end of a 6-axis shaft while being fixed by a second nut, the 6-axis bevel gear A having a bevel gear crest meshing with a bevel gear crest formed on one end of 6-axis bevel gear B for converting the axis of rotation perpendicularly; 6-axis bevel gear B having a bevel gear crest formed on one end thereof so as to mesh with the 6-axis bevel gear A, and having a spur gear crest formed on the other end thereof; 6-axis bevel gear C having a bevel gear crest formed on one end thereof so as to mesh with 6-axis bevel gear D, and having a spur gear crest formed on the other end thereof so as to mesh with the 6-axis bevel gear B; and 6-axis bevel gear D having a bevel gear crest formed on one end thereof so as to mesh with the 6-axis bevel gear C, the other end of the 6-axis bevel gear D being fixed to the input axis of a 6-axis reducer by a third nut. The position in which the 5-axis bevel gear A and the 5-axis bevel gear B mesh and position in which the 6-axis bevel gear A and the 6-axis bevel gear B mesh are determined such that respective axes of rotation are arranged on the same straight line.

### TECHNICAL FIELD

The present invention relates to a vertical multi-joint robot, and more specifically, to an internal fastening structure of a wrist axis of a vertical multi-joint robot.

### BACKGROUND ART

In general, as all industries have become mechanized and automated, the need for mechanical devices capable of replacing humans has been recognized.

Therefore, robots, which are automatic machines that perform functions similar to those of human hands, legs, and head, were developed.

The advent of robots has made it possible to work in harsh conditions that are difficult for humans, and their areas of use are expanding as they are well-suited for precision work.

In the development of such robot systems, the design of the mechanical part has two main purposes.

First, as a part of the system, it should have the functions and performance required by the system and combine with other parts of the system to achieve the intended object. Second, it should have excellent performance in terms of various mechanical characteristics that a robot mechanical part should have, such as repeatability, precision, vibration characteristics, maintainability, and manufacturing cost.

The reason is that even if the robot body exhibits sufficient performance as a part of the system, it can also be used independently as a standalone robot for other tasks.

6-axis vertical multi-joint robots designed to have a structure most similar to the human arm and perform multi-degree-of-freedom movements are widely used across various industrial fields.

A vertical multi-joint robot includes a base, and a shoulder part is coupled to an upper portion of the base, and rotates up and down within a certain range around a rotation axis of the coupled portion.

An arm is coupled to an upper portion of the shoulder part, and also rotates up and down within a certain range around a rotation axis of the coupled portion.

A wrist is coupled to an end of the arm, where work is performed.

In this case, the power to rotate the shoulder part coupled to the upper portion of the base up and down is provided by a second-axis drive motor installed at a position where the upper portion of the base and the lower portion of the shoulder part are coupled, and the power to rotate the arm up and down with respect to the shoulder part is provided by a third-axis drive motor installed at a position where the upper portion of the shoulder part and a rear end of the arm are coupled.

A 6-axis vertical multi-joint robot with such a basic structure is used in a wide variety of industrial fields and is classified into various shapes and sizes according to its application, size, and weight used, and its precision is also gradually improving.

Along with accuracy, it is also important not to cause errors. In this regard, continuous research is needed to improve internal fastening structures and the like so as to prevent errors caused by repeated operations and long-term fatigue.

### CITATION LIST

### Patent Literature

(Patent Document 1) Patent Document: Korean Registered Patent No. 10
(Patent Document 2) Patent Document: Korean Patent Application Publication No. 10-2018-0048216 2032374
(Patent Document 3) Patent Document: Korean Registered Patent No. 10
(Patent Document 4) Patent Document: Korean Patent Application Publication No. 10-2021-0066981

### DISCLOSURE

### Technical Problem

An object of the present invention to solve the above-described problems of the related art is to improve an internal fastening structure of a wrist axes (Axis 5 and Axis 6) of a vertical multi-joint robot to prevent errors in robot operation in advance.

Another object is to make it possible to reduce a size of a head through an internal design of the wrist axis of the vertical multi-joint robot.

The problems to be addressed by the present invention are not limited to the problems described above, and other problems not described will be apparently understood by one skilled in the art from the following description.

### Technical Solution

According to the present invention for solving the above-described problem, a wrist axis fastening structure of a vertical multi-joint robot includes: a fifth-axis shaft and a sixth-axis shaft configured to be driven by respective motors; a fifth-axis bevel gear (A) having one end formed with bevel gear teeth and other end connected to the fifth-axis shaft, and being rotatably supported on the sixth-axis shaft via a bearing; a fifth-axis bevel gear (B) configured to mesh with the gear teeth of the fifth-axis bevel gear (A) at one end of the fifth-axis shaft to convert a rotation axis into a perpendicular direction, the fifth-axis bevel gear (B) being coupled to an input shaft of a fifth-axis reducer and fixed by a first nut; a sixth-axis bevel gear (A) positioned while fixed by a second nut at a tip end of the sixth-axis shaft, and having bevel gear teeth to mesh with bevel gear teeth formed at one end of a sixth-axis bevel gear (B) configured to convert a rotation axis into a perpendicular direction; a sixth-axis bevel gear (B) having one end formed with bevel gear teeth to mesh with the sixth-axis bevel gear (A) and other end formed with spur gear teeth; a sixth-axis bevel gear (C) having one end formed with bevel gear teeth to mesh with a sixth-axis bevel gear (D) and other end formed with spur gear teeth to mesh with the sixth-axis bevel gear (B); and a sixth-axis bevel gear (D) having one end formed with bevel gear teeth to mesh with the sixth-axis bevel gear (C) and other end fixed to an input shaft of a sixth-axis reducer by a third nut, in which the fifth-axis bevel gear (B) and the sixth-axis bevel gear (B) are arranged in an up-down direction with respect to the sixth-axis shaft, and a position where the fifth-axis bevel gear (A) and the fifth-axis bevel gear (B) mesh and a position where the sixth-axis bevel gear (A) and the sixth-axis bevel gear (B) mesh are determined so that respective rotation axes of the fifth-axis bevel gear (B) and the sixth-axis bevel gear (B) are aligned on the same straight line.

Here, preferably, a fastening surface of the first nut has an inclined surface, and the fifth-axis bevel gear (A) has an inclined groove to be correspondingly fastened thereto, and a shim projection surface that acts as a shim is formed between the fifth-axis bevel gear and the fifth-axis reducer on an opposite side to the inclined groove.

Here, preferably, a fastening surface of the second nut has an inclined surface, and the sixth-axis bevel gear (A) has an inclined groove to be correspondingly fastened thereto, and a fastening surface of the third nut has an inclined surface, and the sixth-axis bevel gear (D) has an inclined groove to be correspondingly fastened thereto.

Here, preferably, each of the sixth-axis bevel gear (B) and the sixth-axis bevel gears (C) is formed as an integral structure including a shaft, bevel gear teeth formed at one end of the shaft, and spur gear teeth formed at other end thereof.

### Advantageous Effects

According to the configuration of the present invention described above, it is possible to prevent errors in robot operation in advance by improving an internal fastening structure of a wrist axes (Axis 5 and Axis 6) of a vertical multi-joint robot. In addition, it is possible to reduce a size of a head through an internal design of the wrist axis of the vertical multi-joint robot.

In addition, by designing the internal fastening structure of the wrist axis and integrating the components, screw loosening and backlash caused by long-term operational fatigue can be prevented in advance, ultimately reducing the robot's output error to nearly zero.

However, the effects of the present invention are not limited to the above effects and may be expanded in various ways without departing from the spirit and scope of the present invention.

### DESCRIPTION OF DRAWINGS

FIG. 1 is a perspective view of a 6-axis vertical multi-joint robot according to an exemplary embodiment of the present invention.

FIG. 2 is a diagram showing an internal structure of Axis 5 and Axis 6 (wrist axis) of the 6-axis vertical multi-joint robot according to an exemplary embodiment of the present invention.

FIG. 3 is a diagram of a gear meshing arrangement structure of Axis 5 and Axis 6 of the vertical multi-joint robot of the present invention.

FIG. 4 shows a fixing structure of a fifth-axis bevel gear (A) of Axis 5 of the vertical multi-joint robot of the present invention.

FIG. 5 shows a fixing structure of a fifth-axis bevel gear (A) of Axis 6 of the vertical multi-joint robot of the present invention.

FIG. 6 shows a fixing structure of a fifth-axis bevel gear (D) of Axis 6 of the vertical multi-joint robot of the present invention.

FIG. 7 is a drawing showing a structure of a pair of bevel gears in an Axis 6 portion of the vertical multi-joint robot according to an exemplary embodiment of the present invention.

### BEST MODE

Hereinafter, the wrist axis fastening structure and operational effects of the vertical multi-joint robot according to the present invention will be described with reference to the accompanying drawings.

The detailed description of the specific exemplary embodiments shown in the accompanying drawings is to be read in conjunction with the accompanying drawings, which are considered to be a part of the entire description of the invention. References to directions or orientations are for convenience of description only and are not intended to limit the scope of the present invention in any way.

Specifically, terms indicating positions, such as “down, up, horizontal, vertical, upper, lower, upward, downward, top, and bottom” or derivatives thereof (e.g., “horizontally, downwardly, upwardly,” etc.) should be understood with reference to both the drawings being described and the related descriptions. In particular, since these relative terms are provided only for convenience of description, it is not required that the device of the present invention be configured or operated in a specific direction.

In addition, terms indicating a mutual coupling relationship between components, such as “mounted, attached, connected, joined, and interconnected”, may refer to a state in which individual components are directly or indirectly attached, connected, or fixed, unless otherwise stated, and should be understood as a term that encompasses not only a state in which they are movably attached, connected, or fixed, but also a state in which they are immovable.

When adding reference numerals to components in each drawing, it should be noted that the same components have the same numerals as much as possible even though they are shown in different drawings. In addition, when describing the present invention, a detailed description of related known configurations or functions will be omitted if it is determined that the detailed description makes the gist of the present invention unclear.

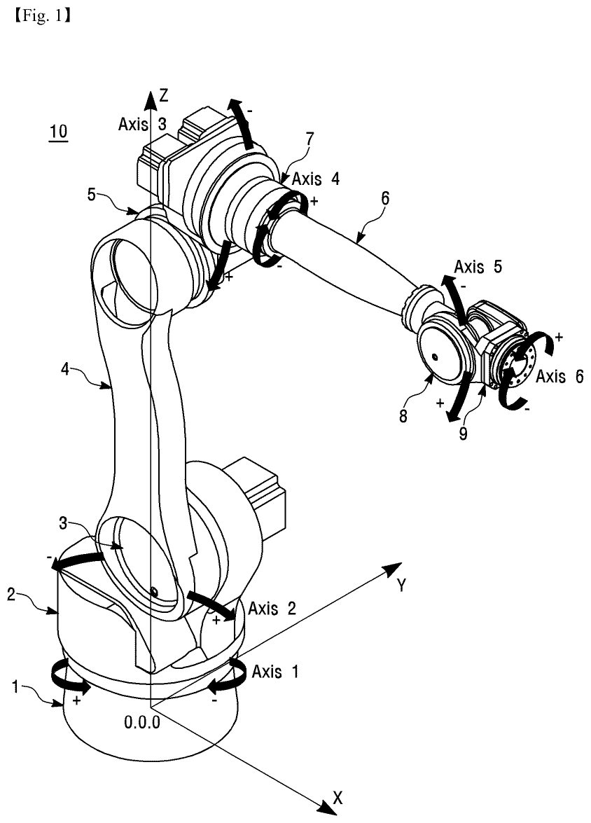

FIG. 1 is a perspective view of a 6-axis vertical multi-joint robot according to an exemplary embodiment of the present invention.

As shown in FIG. 1, a vertical multi-joint robot 10 of the present invention is also commonly called a robot arm or manipulator.

The vertical multi-joint robot 10 includes a base 1 that rotates around a first axis (Axis 1).

A rotating body 2 having a first joint that rotates around the first axis (Axis 1), which is a vertical axis orthogonal to a horizontal plane, may be mounted on the base 1.

A “joint” may include electromechanical elements such as a motor and a reducer that cause movement of the joint, and a sensor that detects a rotation angle of the joint (joint variable).

The vertical multi-joint robot 10 has a second joint 3, which is connected to the base 1 and rotates around a second axis (Axis 2) parallel to the horizontal plane, a first arm 4, which is connected to the second joint 3 and rotates around the second axis (Axis 2), a third joint 5, which is connected to the first arm 4 and rotates around a third axis (Axis 3) parallel to the second axis (Axis 2), and a second arm 6, which is connected to the third joint 5 and rotates around the third axis (Axis 3).

The second arm 6 has a fourth joint 7, which rotates around a fourth axis (Axis 4) orthogonal to the third axis (Axis 3), a fifth joint 8, which rotates around a fifth axis (Axis 5) orthogonal to the fourth axis (Axis 4), and a sixth joint 9, which rotates around a sixth axis (Axis 6) orthogonal to the fifth axis (Axis 5).

An end effector is attached to a tip end of the sixth joint 9.

In the disclosure of the present invention, the fifth joint 8 and the sixth joint 9 form a wrist axis structure of the vertical multi-joint robot. The structure and operating principle of the wrist axis will be described in more detail below.

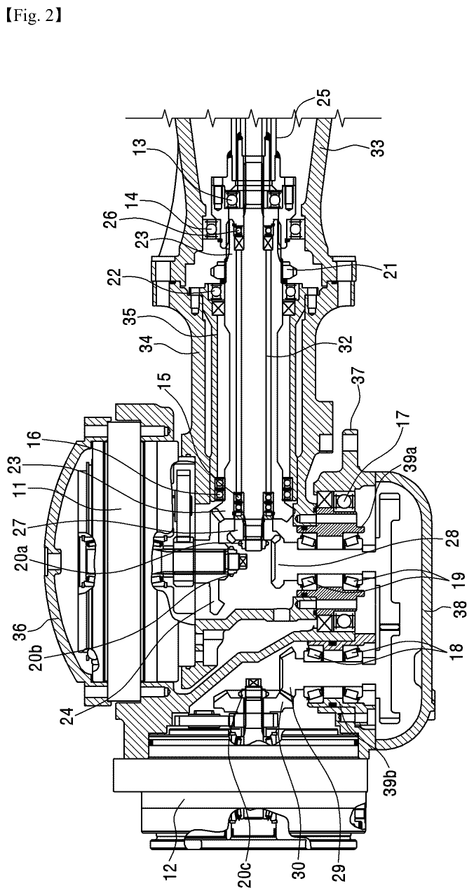

FIG. 2 is a diagram showing an internal structure of Axis 5 and Axis 6 (wrist axis) of the 6-axis vertical multi-joint robot according to an exemplary embodiment of the present invention.

The Axis 5 and Axis 6 of the 6-axis vertical multi-joint robot according to the present invention constitute a wrist axis.

As shown in FIG. 2, the wrist axis may form an external appearance by a fifth-axis body 34 connected to a fourth-axis body (33, a reference sign 6 (hollow cylindrical arm) in FIG. 1), a fifth-axis cover 36 connected to one end of the fifth-axis body 34, and a sixth-axis body 37 and 6-axis cover 38 connected to the other end of the fifth-axis body 34.

A fifth-axis bevel gear (A) 23 connected at other end to a fifth-axis shaft 25, which is connected to a motor (not shown), and having bevel gear teeth formed at one end is rotatably supported on a sixth-axis shaft 32 via bearings 15 and 26.

The sixth-axis shaft 32 is rotatably positioned at the center with respect to a motor (not shown).

The fifth-axis shaft 25 is positioned to be rotatable with respect to the motor (not shown) and is connected at its one end to 23, and a fifth-axis bevel gear (B) 24 is provided which meshes with the teeth of the fifth-axis bevel gear (A) 23 to convert a rotation axis into a perpendicular direction.

The fifth-axis bevel gear (B) 24 is coupled to an input shaft of a fifth-axis reducer 11 and fixed by a nut 20b.

At a tip end of the sixth-axis shaft 32, a sixth-axis bevel gear (A) 27 is positioned while fixed by a nut 20a, and bevel gear teeth of the sixth-axis bevel gear (A) 27 mesh with bevel gear teeth formed at one end of a sixth-axis bevel gear (B) 28 that converts a rotation axis into a perpendicular direction.

The sixth-axis bevel gear (B) 28 is rotatably supported by a bearing 19 within a bearing housing 39a.

Spur gear teeth are formed at the other end of the sixth-axis bevel gear (B) 28, and mesh with a sixth-axis bevel gear (C) 29 having spur gear teeth that mesh with the spur gear teeth.

The other end of the sixth-axis bevel gear (C) 29 is formed with bevel gear teeth and is rotated by meshing with a sixth-axis bevel gear (D) 30 having bevel gear teeth that mesh with the bevel gear teeth to convert a rotation axis into a perpendicular direction.

The sixth-axis bevel gear (C) 29 is rotatably supported by a bearing 18 within a bearing housing 39b.

The sixth-axis bevel gear (D) 30 is coupled to an input shaft of a sixth-axis reducer 12 and fixed by a nut 20c.

An end effector may be fixed to an output shaft of the sixth-axis reducer 12.

Regarding the reference numbers not described, the reference numbers 13, 14, 17, and 22 indicate bearings, the reference number 21 indicates a tightening nut that secures the fifth-axis bevel gear (A) from a side, and the reference number 35 indicates a fifth-axis holder 35 that rotatably supports the fifth-axis bevel gear (A) on an outer periphery side.

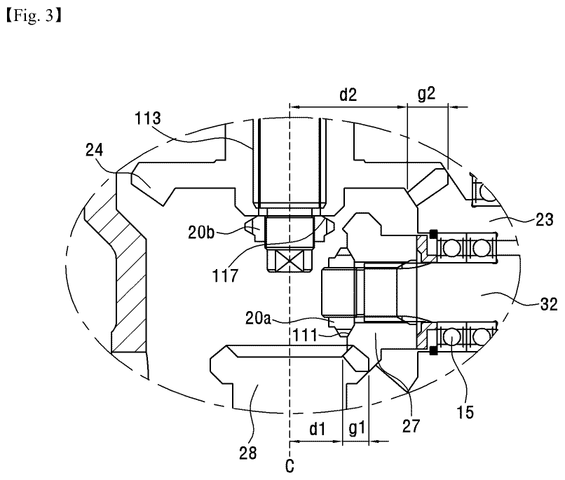

FIG. 3 is a diagram of a gear meshing arrangement structure of Axis 5 and Axis 6 of the vertical multi-joint robot of the present invention.

Referring to FIG. 3, the fifth-axis bevel gear (A) 23 meshes with the fifth-axis bevel gear (B) 24 at their bevel gear teeth to convert the rotational center axis into a perpendicular direction, and the sixth-axis bevel gear (A) 27 fastened to the tip end of the sixth-axis shaft 32 meshes with the sixth-axis bevel gear (B) 28 at their bevel gear teeth to convert the rotational center axis into a perpendicular direction.

The fifth-axis bevel gear (B) 24 and the sixth-axis bevel gear (B) 28 are arranged in an up-down direction with respect to the sixth-axis shaft 32, and their respective rotation axes may be implemented to be aligned on the same straight line.

The purpose of aligning the rotation axes of the fifth-axis bevel gear (B) 24 and the sixth-axis bevel gear (B) 28 on the same straight line is to balance rotations of different objects, similar to aligning the central rotation axis and the rotation axis of the sixth-axis bevel gear (D) 30 on the same line, and also to prevent the head of the vertical multi-joint robot from becoming unnecessarily large.

If the rotation axes of the fifth-axis bevel gear (B) 24 and the sixth-axis bevel gear (B) 28 are different, the size of the head will be inevitably longer by a difference between the rotation axes.

To this end, in the present invention, in a structure in which the fifth-axis bevel gear (B) 24 further protrudes in a forward direction than the sixth-axis bevel gear (B) 28, a distance d1 (a distance between the rotation axis of the sixth-axis bevel gear (B) 28 and the meshed portion) and a distance d2 (a distance between the rotation axis of the fifth-axis bevel gear (B) 24 and the meshed portion) can be accurately set and determined to ensure accurate meshing at positions g1 and g2 where the respective gears mesh with each other based on the central axis.

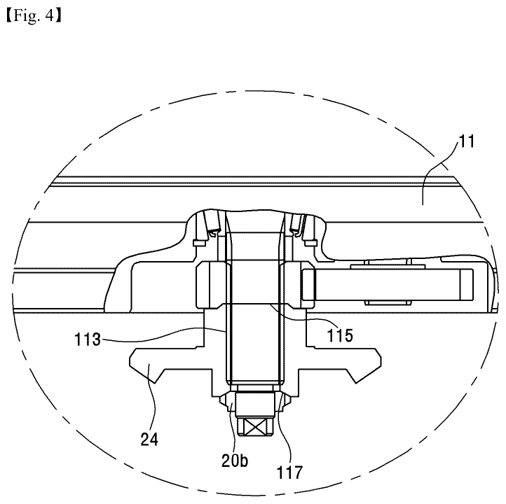

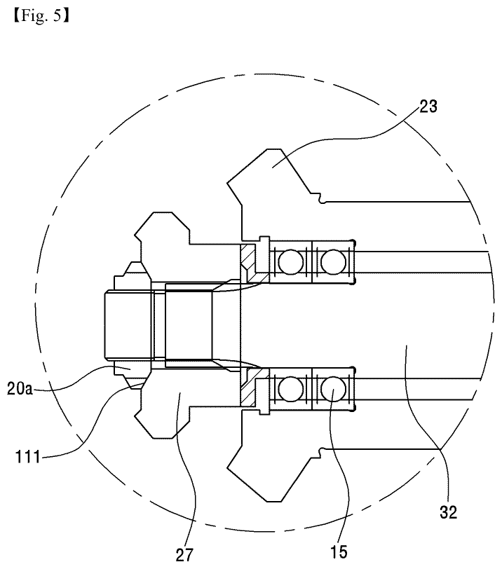

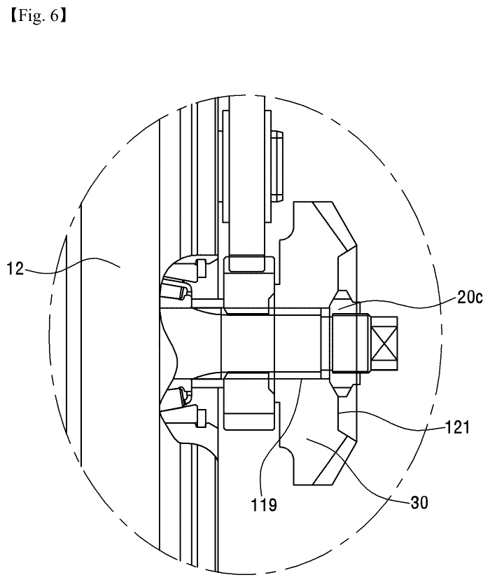

FIG. 4 shows a fixing structure of a fifth-axis bevel gear (A) of Axis 5 of the vertical multi-joint robot of the present invention, FIG. 5 shows a fixing structure of a fifth-axis bevel gear (A) of Axis 6 of the vertical multi-joint robot of the present invention, and FIG. 6 shows a fixing structure of a fifth-axis bevel gear (D) of Axis 6 of the vertical multi-joint robot of the present invention.

FIGS. 4 to 6 show examples of an improved fastening structure of a gear and a nut for preventing a series of errors resulting from repetitive rotation operations.

A nut that secures a gear may become loosened due to fatigue caused by repeated rotational motion and long-term use, leading to backlash. Such small deformations may cause malfunctions in the robot.

Referring to FIG. 4, a fastening structure between the fifth-axis bevel gear (A) 24 and the input shaft of the fifth-axis reducer 11 is shown.

The fifth-axis bevel gear (A) 24 is fastened to the input shaft of the fifth-axis reducer 11 and fixed by the nut 20b.

A fastening surface of the nut 20b has an inclined surface, and the fifth-axis bevel gear (A) 24 has an inclined groove 117 matching the inclined surface.

When the nut 20b fixes the fifth-axis bevel gear (A) 24 to the input shaft of the fifth-axis reducer 11 via the inclined groove 117, the inclined surface and the inclined groove 117 increase the fastening strength and pressure, making it possible to minimize the loosening of the nut.

In addition, a shim projection surface 115 that acts as a shim is formed between the fifth-axis bevel gear and the fifth-axis reducer 11 on an opposite side to the inclined groove 117 (the tip end of the fifth-axis bevel gear (A) 24). The fastening strength is increased by the projection surface 115, so that the fastening strength at both ends of the fifth-axis bevel gear (A) 24 can be further enhanced.

Referring to FIG. 5, the fastening structure between the sixth-axis bevel gear (A) 27 and the fifth-axis shaft 32 is shown.

The sixth-axis bevel gear (A) 27 is fastened to the fifth-axis shaft 32 and fixed by the nut 20a.

A fastening surface of the nut 20a has an inclined surface, and the fifth-axis bevel gear (A) 27 has an inclined groove 111 matching the inclined surface.

When the nut 20a fixes the sixth-axis bevel gear (A) 27 to the fifth-axis shaft 32 via the inclined groove 111, the inclined surface and the inclined groove 111 increase the fastening strength and pressure, making it possible to minimize the loosening of the nut.

Referring to FIG. 6, a fastening structure between the sixth-axis bevel gear (D) 30 and the input shaft of the sixth-axis reducer 12 is shown.

The sixth-axis bevel gear (D) 30 is fastened to an input shaft of the sixth-axis reducer 12 and fixed by the nut 20c.

A fastening surface of the nut 20c has an inclined surface, and the sixth-axis bevel gear (D) 30 has an inclined groove 121 to be properly fastened thereto.

When the nut 20c fixes the sixth-axis bevel gear (D) 30 to the input shaft of the sixth-axis reducer 12 via the inclined groove 121, the inclined surface and the inclined groove 121 increase the fastening strength and pressure, making it possible to minimize the loosening of the nut.

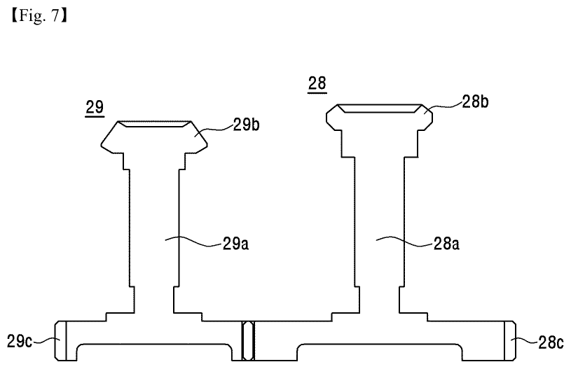

FIG. 7 is a drawing showing a structure of a pair of bevel gears in an Axis 6 portion of the vertical multi-joint robot according to an exemplary embodiment of the present invention.

Each of the sixth-axis bevel gears (B) 28 and the sixth-axis bevel gears (C) 29 has an integrally formed structure that includes a shaft 28a; 29a), bevel gear teeth 28b; 29b formed at one end of the shaft 28a; 29a, and spur gear teeth 28c; 29c formed at the other end.

Referring to FIGS. 2 and 7, the sixth-axis bevel gear (B) 28 meshes at one end with the sixth-axis bevel gear (A) at their bevel gear teeth and meshes at the other end with one end of the sixth-axis bevel gear (C) 29 at their spur gear teeth, and the sixth-axis bevel gear (C) 29 meshes at the other end with the sixth-axis bevel gear (D) 30 at their bevel gear teeth.

Each of the sixth-axis bevel gear (B) 28 and the sixth-axis bevel gear (C) 29 of the present invention has a structure in which the bevel gear teeth are formed at one end and the spur gear teeth are formed at the other end, which are formed integrally.

Although the bevel gear and the spur gear are provided at both ends, the gears are formed integrally, so that the backlash can be reduced compared to a structure in which a bevel gear and a spur gear are fastened.

The internal structure of the wrist axis (Axis 5 and Axis 6) of the vertical multi-joint robot of the present invention, as described above, can prevent loosening and reduce backlash by enhancing the fastening force of gears, and reduce the head size of the robot through the arrangement of the fifth-axis and sixth-axis bevel gears. In addition, the gear composed of a pair of bevel gear and spur gear that enable the sixth-axis bending motion via the fifth-axis is formed as an integral body, making it possible to minimize operating errors of the robot caused by backlash and loosening.

Although the present invention has been described with reference to the limited embodiments and accompanying drawings, it would be appreciated by one skilled in the art that the present invention is not limited thereto but various modifications and alterations can be made without departing from the scope defined in the claims and their equivalents.

However, it is obvious that such simple modifications and alternations are not to be regarded as a departure from the scope of the present invention.

### EXPLANATION OF REFERENCE NUMERALS AND SYMBOLS

| | |
|---|---|
| 10: nut | 11: body |
| 12: wedge portion | 12a: inclined surface |
| 13: female screw portion | 14: bolt |
| 15: fixed object | 16: bolt hole |
| 17: interval | |

1. A wrist axis fastening structure of a vertical multi-joint robot, comprising:
a fifth-axis shaft and a sixth-axis shaft configured to be driven by respective motors;
a fifth-axis bevel gear (A) having one end formed with bevel gear teeth and other end connected to the fifth-axis shaft, and being rotatably supported on the sixth-axis shaft via a bearing;
a fifth-axis bevel gear (B) configured to mesh with the gear teeth of the fifth-axis bevel gear (A) at one end of the fifth-axis shaft to convert a rotation axis into a perpendicular direction, the fifth-axis bevel gear (B) being coupled to an input shaft of a fifth-axis reducer and fixed by a first nut;
a sixth-axis bevel gear (A) positioned while fixed by a second nut at a tip end of the sixth-axis shaft, and having bevel gear teeth to mesh with bevel gear teeth formed at one end of a sixth-axis bevel gear (B) configured to convert a rotation axis into a perpendicular direction;
a sixth-axis bevel gear (B) having one end formed with bevel gear teeth to mesh with the sixth-axis bevel gear (A) and other end formed with spur gear teeth;
a sixth-axis bevel gear (C) having one end formed with bevel gear teeth to mesh with a sixth-axis bevel gear (D) and other end formed with spur gear teeth to mesh with the sixth-axis bevel gear (B); and
a sixth-axis bevel gear (D) having one end formed with bevel gear teeth to mesh with the sixth-axis bevel gear (C) and other end fixed to an input shaft of a sixth-axis reducer by a third nut,
wherein the fifth-axis bevel gear (B) and the sixth-axis bevel gear (B) are arranged in an up-down direction with respect to the sixth-axis shaft, and a position where the fifth-axis bevel gear (A) and the fifth-axis bevel gear (B) mesh and a position where the sixth-axis bevel gear (A) and the sixth-axis bevel gear (B) mesh are determined so that respective rotation axes of the fifth-axis bevel gear (B) and the sixth-axis bevel gear (B) are aligned on the same straight line.

2. The wrist axis fastening structure of a vertical multi-joint robot of claim 1, wherein
a fastening surface of the first nut has an inclined surface, and the fifth-axis bevel gear (A) has an inclined groove to be correspondingly fastened thereto, and
a shim projection surface that acts as a shim is formed between the fifth-axis bevel gear and the fifth-axis reducer on an opposite side to the inclined groove.

3. The wrist axis fastening structure of a vertical multi-joint robot of claim 2, wherein
a fastening surface of the second nut has an inclined surface, and the sixth-axis bevel gear (A) has an inclined groove to be correspondingly fastened thereto, and
a fastening surface of the third nut has an inclined surface, and the sixth-axis bevel gear (D) has an inclined groove to be correspondingly fastened thereto.

4. The wrist axis fastening structure of a vertical multi-joint robot of claim 2, wherein each of the sixth-axis bevel gear (B) and the sixth-axis bevel gears (C) is formed as an integral structure including a shaft, bevel gear teeth formed at one end of the shaft, and spur gear teeth formed at other end thereof.
